(19) United States
(12) Patent Application Publication
(10) Pub. No.: US 2016/0052431 A1
(43) Pub. Date: Feb. 25, 2016

(54) SYSTEMS AND METHODS FOR ACTIVE SEAT DAMPER

(71) Applicant: GM GLOBAL TECHNOLOGY OPERATIONS LLC, Detroit, MI (US)

(72) Inventors: LUKE D. BARNARD, WOODHAVEN, MI (US); ROBERT D. SCHEIDT, WHITE LAKE, MI (US); HUW A. EVANS, ROYAL OAK, MI (US)

(21) Appl. No.: 14/462,939

(22) Filed: Aug. 19, 2014

(51) Int. Cl. B60N 2/50; B60N 2/02

(52) U.S. Cl. CPC B60N 2/501; B60N 2/02

(57) ABSTRACT

Methods and apparatus are provided for an active seat damper. The method of controlling a damper of a seat of a vehicle includes receiving data indicating a condition associated with the seat and determining a natural frequency of the seat based on the condition. The method also includes outputting one or more control signals to control a natural frequency of the damper based on the natural frequency of the seat.

### TECHNICAL FIELD

The present disclosure generally relates to vibration mitigation and more particularly relates to systems and methods for mitigating vibration in a seat of a vehicle.

### BACKGROUND

In certain driving conditions, an operator and/or passengers may experience vibrations during the operation of a vehicle. The vibrations may be transmitted to the operator from the seat on which the operator and/or passenger is sitting. In addition, if one or more of the seats of the vehicle are unoccupied during operation of the vehicle, the vehicle seat may vibrate visibly during the operation of the vehicle. These vibrations experienced during the operation of the vehicle may lead to operator dissatisfaction and may result in unwanted noise.

Accordingly, it is desirable to provide improved systems and methods for mitigating vibration of the seats of the vehicle during the operation of the vehicle. Furthermore, other desirable features and characteristics of the present invention will become apparent from the subsequent detailed description and the appended claims, taken in conjunction with the accompanying drawings and the foregoing technical field and background.

### SUMMARY

In one embodiment, a method is provided for controlling a damper of a seat of a vehicle. The method includes receiving data indicating a condition associated with the seat and determining a natural frequency of the seat based on the condition. The method also includes outputting one or more control signals to control a natural frequency of the damper based on the natural frequency of the seat.

In one embodiment, an apparatus is provided for a damper control system for a seat of a vehicle. The apparatus includes at least one sensor that determines a condition of the seat and a damper control module that controls the damper based on the condition of the seat.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle that includes an active seat damper system in accordance with various embodiments;

FIG. 2 is a dataflow diagram illustrating a control system of the active seat damper system in accordance with various embodiments;

FIG. 3 is a flowchart illustrating a control method of the active seat damper system in accordance with various embodiments; and

FIG. 4 is a flowchart illustrating a control method of the active seat damper system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

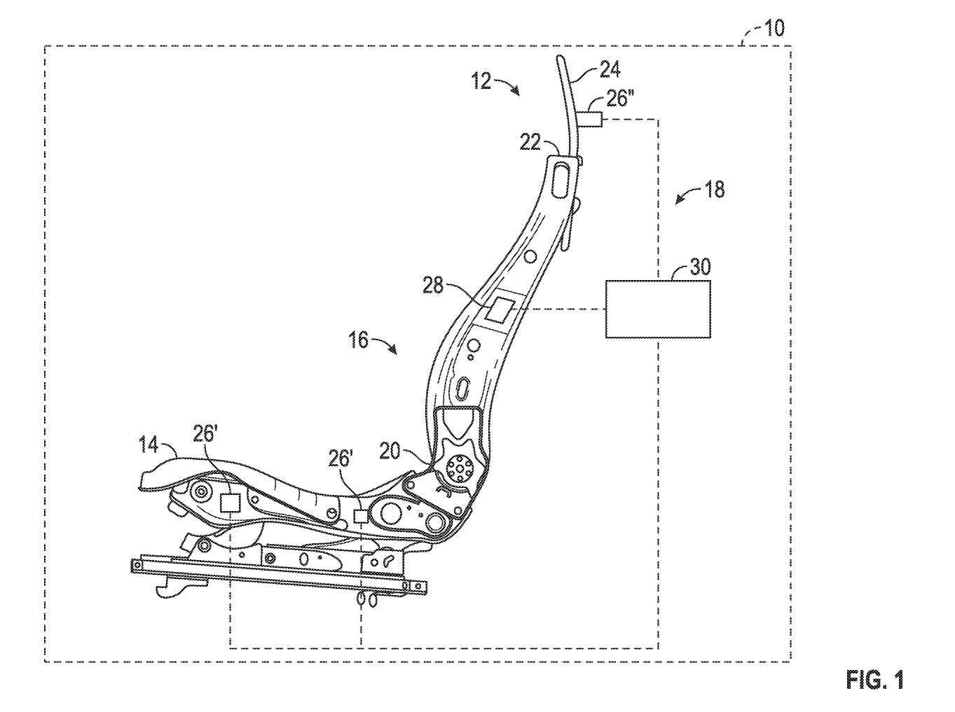

With reference to FIG. 1, a vehicle 10 is shown. The vehicle 10 includes one or more occupant seats 12. For clarity, a single seat 12 is illustrated herein, but the vehicle 10 can have any number of seats 12, and thus, FIG. 1 is merely exemplary. The seat 12 includes a seat bottom 14, a seat back 16 and an active seat damper system 18 in accordance with various embodiments. Although the figures shown herein depict an example with certain arrangements of elements, additional intervening elements, devices, features, or components may be present in an actual embodiment. It should also be understood that FIG. 1 is merely illustrative and may not be drawn to scale.

The seat bottom 14 provides a seating surface for an occupant of the vehicle 10, as is generally known in the art. The seat bottom 14 may have any desired shape, and may be covered with any desired covering for comfort and to provide an aesthetically pleasing appearance. The seat bottom 14 may be movably coupled to the vehicle 10, such that the seat 12 may be positionable at various locations within the vehicle 10 as is generally known.

The seat back 16 is coupled to the seat bottom 14 for supporting an occupant's back. Generally, the seat back 16 is movably coupled to the seat bottom 14 such that the seat back 16 may be moved through a variety of inclined angles relative to the seat bottom 14, as is generally known in the art. In one example, the seat back 16 includes a first end 20 and a second end 22. The first end 20 is movably coupled to the seat bottom 14, and the second end 22 may be coupled to a headrest 24 for supporting an occupant's head. It should be noted that the seat 12 is merely exemplary, and thus, the seat 12 need not include a headrest 24.

The active seat damper system 18 is coupled to the seat 12. In one example, the active seat damper system 18 includes at least one sensor 26, a damper 28 and a control module 30. In one embodiment, the active seat damper system 18 includes one or more mass sensors 26′. The one or more mass sensors 26′ measure and observe a mass of an item seated on the seat bottom 14 and generate sensor signals based thereon. Generally, the one or more mass sensors 26′ measure and observe any mass positioned upon the seat bottom 14, and thus, the one or more mass sensors 26′ may generate sensor signals that indicate that an occupant is seated in the seat 12 or if the seat 12 is unoccupied based on the observed mass. It should be noted that while the one or more mass sensors 26′ are illustrated as being coupled to the seat bottom 14, the one or more mass sensors 26′ may be coupled to the seat 12 at any desired location to measure a mass associated with the seat 12, including, but not limited to, the seat back 16.

In one embodiment, the at least one sensor 26 includes one or more acceleration sensors or accelerometers 26″. The one or more accelerometers 26″ measure and observe an acceleration of the seat 12 and generate sensor signals based thereon. Generally, the one or more accelerometers 26″ measure an absolute acceleration observed by the one or more accelerometers 26″. In one example, the one or more accelerometers 26″ are coupled to the headrest 24, however, the one or more accelerometers 26″ may be coupled to the seat 12 at any desired location to observe an acceleration associated with the seat 12. In addition, the one or more accelerometers 26″ may be coupled to any portion of the vehicle 10 to measure an acceleration of the vehicle 10 and generate sensor signals based thereon. Thus, the location of the one or more accelerometers 26″ is merely exemplary. In addition, it should be noted that the sensors 26′, 26″ are merely exemplary, as any number of sensors 26 could be employed and further, one or more of the conditions measured by the sensors 26′, 26″ can be derived from other sources, such as by modeling, for example.

The damper 28 is coupled to the seat 12. The damper 28 is adjustable or tunable based upon receipt of one or more control signals from the control module 30 to vary a natural frequency of the damper 28, and thus, the seat 12, as will be discussed in greater detail herein. In one example, the damper 28 is coupled to the seat back 16, however, the damper 28 may be coupled to any desired portion of the seat 12 to influence a natural frequency or vibration behavior of the seat 12. The damper 28 comprises any suitable adjustable or tunable damper, in which the natural frequency of the damper is variable based on receipt of one or more control signals, including, but not limited to, a magnetorheological damper, tuned mass damper or a tuned vibration absorber. Generally, the natural frequency of the damper 28 is adjustable between a minimum natural frequency, such as about 1.5 Hertz (Hz) for example, and a maximum natural frequency, such as about 4 Hertz (Hz), for example. By adjusting the natural frequency of the damper 28, the natural frequency of the seat 12 may be tuned or varied to correspond with a mass of an item, such as an occupant, seated in the seat 12, or if unoccupied, to correspond with the mass of the seat 12 itself. By varying or tuning the natural frequency of the damper 28 to correspond with a condition or mass associated with the seat 12, vibrations associated with the seat 12 during the operation of the vehicle 10 may be minimized, thereby improving operator satisfaction.

In various embodiments, the control module 30 controls the operation of the damper 28 based on one or more of the sensor signals and further based on the active seat damper systems and methods of the present disclosure to mitigate vibration experienced by the seat 12 of the vehicle 10. As will be discussed, the control module 30 outputs one or more control signals to the damper 28 to adjust a natural frequency of the damper 28 based on the sensor signals from the at least one sensor 26. It should be noted that the control module 30 is in communication with the at least one sensor 26 and damper 28 over any suitable communication architecture associated with the vehicle 10.

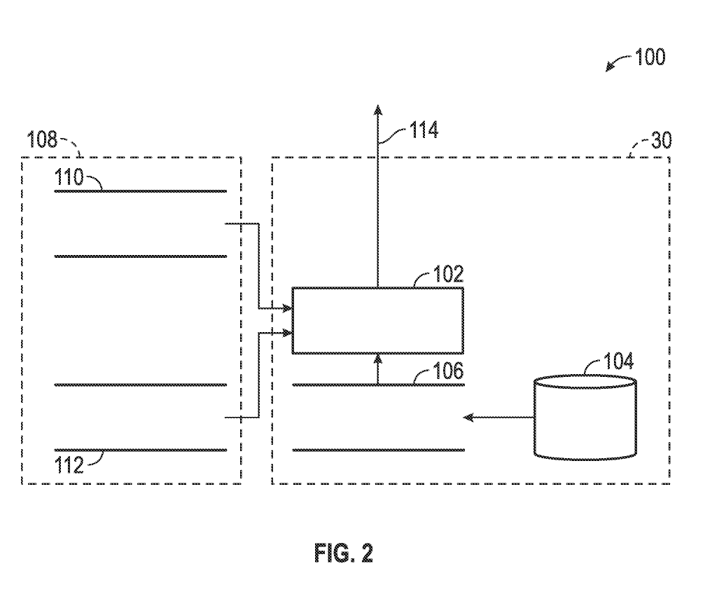

Referring now to FIG. 2, and with continued reference to FIG. 1, a dataflow diagram illustrates various embodiments of a damper control system 100 for the seat 12 (FIG. 1) that may be embedded within the control module 30. Various embodiments of the damper control system according to the present disclosure can include any number of sub-modules embedded within the control module 30. As can be appreciated, the sub-modules shown in FIG. 2 can be combined and/or further partitioned to similarly adjust the natural frequency of the damper 28 of the active seat damper system 18 (FIG. 1). Inputs to the system can be sensed from the vehicle 10 (FIG. 1), received from other control modules (not shown), and/or determined/modeled by other sub-modules (not shown) within the control module 30. In various embodiments, the control module 30 includes a damper control module 102 and a tables datastore 104.

In one embodiment, the tables datastore 104 stores one or more tables (e.g., lookup tables) that indicate a natural frequency for the damper 28 based on the mass input to the one or more mass sensors 26′ and a known mass of the seat 12. In other words, the tables datastore 104 stores one or more tables that provide natural frequency values for the damper 28 based on various masses of the seat system observed by the one or more mass sensors 26′ and the known mass of the seat 12. In one example, the one or more tables are populated using the following equation:

$$M = \frac{1}{4 {π}^{2}} ( \frac{{K}_{system}}{{Z}^{2}} ) \qquad ( 1 )$$

Wherein, M is the sum of the known mass of the seat 12 and the mass observed by the one or more mass sensors 26′ in kilograms (kg) multiplied by a correlation coefficient (no units) for a percent of a mass measured by the one or more mass sensors 26′ that acts on the seat back 16 (the effective mass); K_{system} is the stiffness of the seat system comprising of the seat 12 and damper 28 in Newtons per meter (N/m); and Z is the natural frequency of the seat system that the damper 28 will be set to in Hertz (Hz).

In various embodiments, the tables can be interpolation tables that are defined by one or more indexes. A natural frequency value 106 provided by at least one of the tables indicates a desired natural frequency for the damper 28 to arrive at a natural frequency for the seat 12 based on the mass input. As an example, one or more tables can be indexed by parameters such as, but not limited to, mass of an occupant on the seat 12 and the seat 12 itself, to provide the natural frequency value 106. Thus, the natural frequency value 106 indicates a natural frequency for the damper 28 based on a particular mass observed by the one or more mass sensors 26′.

In one embodiment, the tables datastore 104 stores one or more tables (e.g., lookup tables) that indicate a natural frequency for the damper 28 based on the acceleration input to the one or more accelerometers 26″. In other words, the tables datastore 104 stores one or more tables that provide natural frequency values for the damper 28 based on various accelerations observed by the one or more accelerometers 26″. In various embodiments, the tables can be interpolation tables that are defined by one or more indexes. The natural frequency value 106 provided by at least one of the tables indicates a desired natural frequency for the damper 28 to arrive at a natural frequency for the seat 12 based on the acceleration input. As an example, one or more tables can be indexed by parameters such as, but not limited to, the frequency of peak acceleration of the seat 12, to provide the natural frequency value 106. In this example, the natural frequency values for the damper 28 correspond directly to a measured frequency of a peak acceleration by the one or more accelerometers 26″. For example, the one or more tables are populated using the following equation:

$${Z}_{damper} = \frac{1}{2 π} {AZ}_{accel} \qquad ( 2 )$$

Wherein, Z_{damper} is the frequency of the damper in Hertz (Hz), A is a correlation coefficient (no units) and Z_{accel} is the frequency of the peak acceleration in Hertz (Hz). In one example, A is about 1.0 or less. Thus, the natural frequency value 106 indicates a natural frequency for the damper 28 based on a particular acceleration observed by the one or more accelerometers 26″.

The damper control module 102 receives as input sensor data 108 from at least one sensor 26. The sensor data 108 indicates one or more conditions associated with the seat 12. The damper control module 102 generates one or more control signals 114 to the damper 28 based on the sensor data 108. In various embodiments, the damper control module 102 receives mass data 110 from the one or more mass sensors 26′. Based on the mass data 110, the damper control module 102 determines if the seat 12 is occupied or unoccupied. For example, if the mass data 110 is greater than a mass of the seat 12, then the damper control module 102 determines that the seat 12 is occupied. If the seat 12 is unoccupied, the damper control module 102 determines the natural frequency value 106 to be a maximum natural frequency value.

The damper control module 102 also determines, based on the mass data 110, if the mass data 110 is greater than a predefined threshold for an occupant mass on the seat 12. For example, the damper control module 102 determines if the mass data 110 indicates that the occupant mass is greater than a 95^{th} percentile for occupant mass. If the mass data 110 is greater than the predefined threshold, the damper control module 102 determines the natural frequency value 106 to be a minimum natural frequency value.

If the mass data 110 is below the predefined threshold and the seat 12 is occupied, the damper control module 102 determines the natural frequency value 106 from the one or more tables of the tables datastore 104 based on the mass data 110 (e.g., by performing a lookup function on the tables to determine a natural frequency value using the mass observed by the one or more mass sensors 26′ and the known mass of the seat 12). A natural frequency of the seat 12 is determined from the mass data 110. For example, the damper control module 102 determines a natural frequency of the seat 12 based on the following equation:

$$\frac{1}{2 π} ( \sqrt{\frac{{K}_{seat}}{M}} ) = Z \qquad ( 3 )$$

Wherein, M is the sum of the known mass of the seat 12 and the mass observed by the one or more mass sensors 26′ (i.e. mass data 110) in kilograms (kg) multiplied by a correlation coefficient (no units) for a percent of a mass measured by the one or more mass sensors 26′ that acts on the seat back 16 (the effective mass); Kₛₑₐₜ is the known stiffness of the seat 12 in Newtons per meter (N/m); and Z is the natural frequency of the of the seat 12 in Hertz (Hz). Based on the natural frequency of the seat 12, the damper control module 102 outputs the one or more control signals 114 to adjust the natural frequency of the damper 28 to create an equivalent natural frequency of the damper 28, thereby reducing vibrations associated with the seat 12.

In various embodiments, the damper control module 102 receives acceleration data 112 from the one or more accelerometers 26″. The damper control module 102 determines if the acceleration data 112 is greater than a predefined threshold for acceleration. In one embodiment, the damper control module 102 receives an absolute acceleration measured and observed by the one or more accelerometers 26″ and determines if the absolute acceleration measured and observed by the one or more accelerometers 26″ is greater than the predefined threshold.

In one embodiment, if two accelerometers 26″ are employed with the damper control system 18, the damper control module 102 receives the absolute acceleration measured and observed by each of the accelerometers 26″ and determines if the difference between the two values (i.e. the relative acceleration between the two accelerometers 26″) is greater than the predefined threshold. For example, the damper control module 102 determines if the acceleration is greater than about 0.1 meters per second squared (m/s²). It should be noted that this predefined threshold is merely exemplary, as the predefined threshold may vary based on the speed of the vehicle 10 and/or an operating condition of the vehicle 10, such as between about 0.1 m/s² or about 1.0 m/s². If the acceleration data 112 is greater than the predefined threshold, the damper control module 102 determines the natural frequency value 106 from the one or more tables of the tables datastore 104 based on the acceleration data 112 (e.g., by performing a lookup function on the tables to determine a natural frequency value using the acceleration observed by the one or more accelerometers 26″). The one or more control signals 114 are generated to the damper 28 based on the acceleration data 112 to control the natural frequency of the damper 28 based on the current acceleration associated with the seat 12 (i.e. the acceleration of the seat 12 observed by the one or more accelerometers 26″).

It should be noted that if the acceleration data 112 is less than the predefined threshold, the natural frequency for the damper 28 may be set to a predefined or default value and/or may be determined based on the mass data 110, as discussed previously herein.

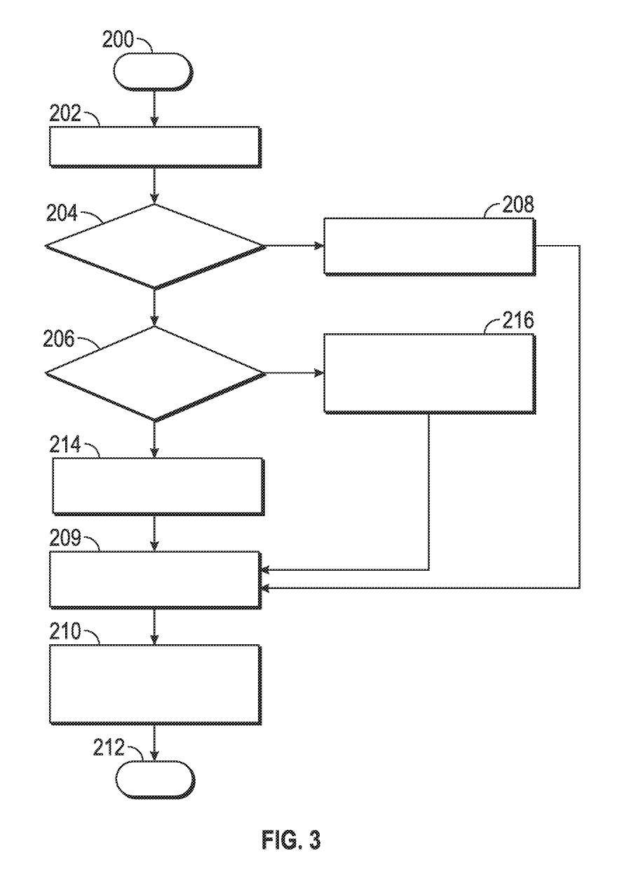

Referring now to FIG. 3, and with continued reference to FIGS. 1 and 2, a flowchart illustrates a control method that can be performed by the control module 30 of FIG. 1 in accordance with the present disclosure. As can be appreciated in light of the disclosure, the order of operation within the method is not limited to the sequential execution as illustrated in FIG. 3, but may be performed in one or more varying orders as applicable and in accordance with the present disclosure.

In various embodiments, the method can be scheduled to run based on predetermined events, and/or can run continually during operation of the vehicle 10.

The method begins at 200. At 202, the method can receive the mass data 110 from the one or more mass sensors 26′. Based on the mass data 110, at 204, the method determines if the seat 12 is occupied or unoccupied. In other words, if the mass data 110 indicates a mass measured greater than a mass of the seat 12, then the method determines that the seat 12 is occupied. If the seat 12 is occupied, the method goes to 206. Otherwise, the method goes to 208.

At 208, the method sets the natural frequency value for the damper 28 as a maximum natural frequency value based on the seat 12 being unoccupied. In one example, the maximum natural frequency value is a default value. At 209, the method determines the natural frequency for the seat 12 using the equation (3) from above. At 210, based on the natural frequency of the seat 12, the method outputs the one or more control signals 114 to adjust the natural frequency of the damper 28 to create an equivalent natural frequency of the damper 28, thereby reducing vibrations associated with the seat 12. Then, the method ends at 212.

At 206, the method determines if the mass data 110 is greater than a predefined threshold for an occupant mass on the seat 12. For example, the method determines if the mass data 110 indicates that the occupant mass is greater than a 95^{th} percentile for occupant mass. If the mass data 110 is greater than the predefined threshold, the method goes to 214. Otherwise, at 216, the method determines the natural frequency value 106 from the tables of the tables datastore 104 based on the mass data 110 and the seat mass (known value). At 209, the natural frequency of the seat 12 is determined based on the mass data 110 and the seat mass using equation (3).

At 214, the method determines the natural frequency value 106 is a minimum natural frequency value for the damper 28 based on the occupant mass from the mass data 110 being greater than the predefined threshold. In one example, the minimum natural frequency value is a default value. At 209, the natural frequency of the seat 12 is determined based on the mass data 110 and the seat mass using equation (3).

It should be noted that blocks 206, 216, 218 may be optional, as the method can adjust the natural frequency of the seat 12, and thus the damper 28, based on whether the seat 12 is occupied or unoccupied from the mass data 110. Thus, the method illustrated herein is merely exemplary.

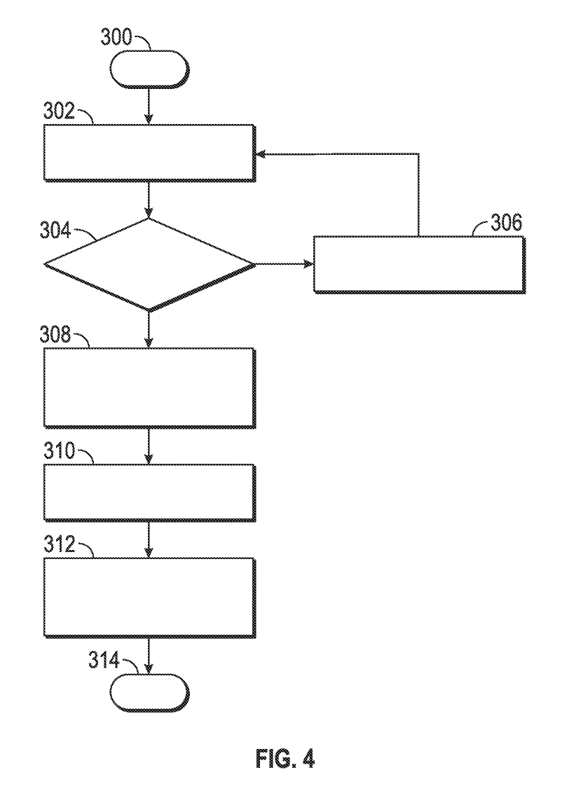

Referring now to FIG. 4, and with continued reference to FIGS. 1 and 2, a flowchart illustrates a control method that can be performed by the control module 30 of FIG. 1 in accordance with the present disclosure. As can be appreciated in light of the disclosure, the order of operation within the method is not limited to the sequential execution as illustrated in FIG. 4, but may be performed in one or more varying orders as applicable and in accordance with the present disclosure.

In various embodiments, the method can be scheduled to run based on predetermined events, and/or can run continually during operation of the vehicle 10.

The method begins at 300. At 302, the method can receive the acceleration data 112 from the one or more accelerometers 26″. At 304, the method determines if the acceleration data 112 is greater than a predefined threshold for acceleration. For example, the method determines if the acceleration is greater than about 0.1 m/s². If the acceleration data 112 is not greater than the predefined threshold, the method goes to 306. At 306, the method waits a predetermined time period, such as about 10 seconds to about 25 seconds, before looping to 302.

Otherwise, if the acceleration data 112 is greater than the predefined threshold, the method goes to 308. At 308, the method determines the natural frequency value 106 from the tables of the tables datastore 104 based on the acceleration data 112. At 310, the natural frequency of the seat 12 is determined based on the natural frequency value 106 derived from the acceleration data 112. At 312, based on the natural frequency of the seat 12, the method outputs the one or more control signals 114 to adjust the natural frequency of the damper 28 to create an equivalent natural frequency of the damper 28, thereby reducing vibrations associated with the seat 12. Then, the method ends at 314.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a damper of a seat of a vehicle, comprising:
receiving data indicating a condition associated with the seat;
determining a natural frequency of the seat based on the condition; and
outputting one or more control signals to control a natural frequency of the damper based on the natural frequency of the seat.

2. The method of claim 1, wherein the condition is a mass and the receiving data comprises receiving mass data from one or more mass sensors associated with the seat.

3. The method of claim 1, wherein the condition is an acceleration and the receiving data comprises receiving acceleration data from one or more acceleration sensors associated with the seat.

4. The method of claim 1, further comprising:
determining a natural frequency value for the damper based on the condition.

5. The method of claim 4, wherein the determining the natural frequency of the seat comprises determining the natural frequency of the seat based on the natural frequency value for the damper and the condition associated with the seat.

6. The method of claim 4, wherein the natural frequency value for the damper is a default value.

7. The method of claim 4, wherein the determining the natural frequency value for the damper comprises determining the natural frequency value from one or more tables of a datastore based on the condition.

8. A damper control system for a seat of a vehicle, comprising:
at least one sensor that determines a condition of the seat; and
a damper control module that controls the damper based on the condition of the seat.

9. The system of claim 8, wherein the damper control module controls a natural frequency of the damper.

10. The system of claim 8, wherein the at least one sensor is at least one mass sensor, and the at least one mass sensor determines a mass on a surface of the seat.

11. The system of claim 8, wherein the at least one sensor is at least one acceleration sensor, and the at least one acceleration sensor determines an acceleration of a portion of the seat.

12. The system of claim 10, wherein the damper control module determines a natural frequency of the damper based on the mass on the surface of the seat and a mass of the seat; determines a natural frequency of the seat based on the natural frequency of the damper and the mass on the surface of the seat and a mass of the seat; and controls the natural frequency of the damper based on the natural frequency of the seat.

13. The system of claim 11, wherein the damper control module determines a natural frequency of the damper based on the acceleration of the portion of the seat; determines a natural frequency of the seat based on the natural frequency of the damper and the acceleration of the portion of the seat; and controls the natural frequency of the damper based on the natural frequency of the seat.

14. A vehicle, comprising:
a seat;
a damper coupled to the seat, the damper having an adjustable natural frequency;
at least one sensor associated with the seat that determines at least one of a mass on a surface of the seat and an acceleration of a portion of the seat; and
a damper control module that controls the damper based on at least one of the mass on the surface of the seat and the acceleration of the portion of the seat.

15. The vehicle of claim 14, wherein the control module controls the damper based on a natural frequency of the seat.

16. The vehicle of claim 15, wherein the control module determines the natural frequency based on a natural frequency of the damper and at least one of the mass on the surface of the seat and the acceleration of the portion of the seat.

17. The vehicle of claim 16, wherein the natural frequency of the damper is a default value.

18. The vehicle of claim 16, wherein the natural frequency of the damper is determined from one or more tables of a datastore based on at least one of the mass on the surface of the seat and the acceleration of the portion of the seat.

19. The vehicle of claim 14, wherein the seat includes a seat bottom and the at least one sensor comprises at least one mass sensor coupled to the seat bottom that determines the mass on the surface of the seat bottom.

20. The vehicle of claim 14, wherein the seat includes a seat back having a headrest, and the at least one sensor comprises at least one accelerometer coupled to the headrest that determines the acceleration of the headrest.
